(19) United States
(12) Patent Application Publication
(10) Pub. No.: US 2004/0069811 A1
(43) Pub. Date: Apr. 15, 2004

(54) Fixing member for fixing a dispensing member to an opening of a reservoir, and a dispenser including such a fixing member

(75) Inventors: Fabrice Perignon, Verneuil Sur Avre (FR); Fabienne Uguen, Le Val David (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S.

(21) Appl. No.: 10/677,384

(22) Filed: Oct. 3, 2003

Related U.S. Application Data
(60) Provisional application No. 60/428,231, filed on Nov. 22, 2002.

(30) Foreign Application Priority Data
Oct. 10, 2002 (FR) FR-02.12599

(51) Int. Cl. G01F 11/06

(52) U.S. Cl. 222/321.7

(57) ABSTRACT

A fixing member (100) for fixing a dispensing member (3) to an opening (20) of a reservoir (2), said fixing member having means (132) designed to receive the dispensing member, and a substantially cylindrical skirt (110) designed to be engaged in the opening of the reservoir to establish leaktight contact therein, said fixing member being characterized in that the skirt is provided with at least one vent (115) passing through the thickness of the skirt.

### CROSS REFERENCE TO RELATED APPLICATION

This application claims the benefit under 35 U.S.C. §119(e) of pending U.S. provisional patent application Serial No. 60/428,231, filed Nov. 22, 2002, and priority under 35 U.S.C. §119(a)-(d) of French patent application No. FR-02.12599, filed Oct. 10, 2002.

### BACKGROUND OF THE INVENTION

The present invention relates to a fixing member for fixing a dispensing member to an opening of a reservoir, and it also relates to a dispenser using such a dispensing member. The fixing member generally has means, e.g. snap-fastening means, designed to receive the dispensing member. In addition, the fixing member can have a substantially cylindrical skirt designed to be engaged by force into the opening of the reservoir to establish leaktight contact therein. This type of fixing member is in frequent use in fluid dispensers in the fields of perfumes, cosmetics, or indeed pharmaceuticals.

Document EP-0 823 288 describes a fixing member of this type. The skirt of that fixing member can come into engagement inside or outside the opening formed by the reservoir. In the version in which the skirt is engaged by force inside the reservoir, said skirt has a continuous cylindrical top portion and a vertically-grooved cylindrical bottom portion. The vertically-grooved portion extends down to the bottom end of the skirt. Thus, while the skirt is being engaged into the opening of the reservoir, the air present inside the reservoir can escape therefrom via the vertical grooves. Thus, as the skirt is pushed into the opening, the air escapes from it until the continuous cylindrical top portion comes into leaktight tight-fitting engagement in the opening of the reservoir. Whereupon, the inside of the reservoir is isolated from the outside in leaktight manner. Final assembly is obtained when a radial collar formed by the skirt comes into abutment against the top end of the opening of the reservoir. A comparable venting system is described in EP-0 628 355, in which a fixing member supporting a pump has a skirt formed with a continuous cylindrical top segment below which a series of vertical grooves are formed serving to vent the reservoir before the fixing member is finally fitted.

The fixing member of Document EP-0 823 288 is more particularly designed to be fitted to reservoirs of small capacity and made of glass. In general, such reservoirs are sample dispensers. The problem with this type of small glass bottle is that the tolerance on the inside diameter of the bottle is relatively large. As a result, the vertical grooves formed on the bottom portion of the skirt can be completely flattened when the inside diameter of the opening of the bottle is small. To mitigate those drawbacks, it is possible to increase the depth of the grooves, but that makes it necessary to form the skirt with a larger wall thickness, which is incompatible with it being used in samples for reasons of size.

### BRIEF SUMMARY OF THE INVENTION

An object of the present invention is to remedy the above-mentioned drawback of the prior art by defining a fixing member that implements another type of venting.

To this end, the present invention makes provision for the skirt to be provided with at least one vent passing through the thickness of the skirt. Thus, the inside of the skirt situated inside the reservoir can communicate with the outside so long as sealing is not formed above the vent. Unlike in the above-mentioned prior art documents, the path for the air from the reservoir no longer extends along the outside wall of the skirt, but rather it extends inside the skirt and via the through vent.

In an embodiment, the vent is formed below a larger-diameter top segment designed to come into leaktight tight-fitting contact in the opening. It is precisely this larger-diameter top segment which interrupts the communication between the vent and the outside at the end of fitting of the fixing member in the opening of the reservoir. It does not matter if sealing is already provided below the vent because it does not prevent the air from exiting from the reservoir through the vent.

According to another characteristic of the invention, the vent is formed at a larger-diameter middle segment designed to come into leaktight tight-fitting contact in the opening. Thus, sealing may be formed directly around the vent, where it opens out onto the outside wall of the skirt. The diameter of the middle segment may be identical to the diameter of the top segment, but it is also possible to provide a middle segment that has a diameter that is smaller than the diameter of the top segment, or at least smaller than the diameter of a portion of the top segment.

In another aspect of the invention, the vent is formed above a bottom segment including a larger-diameter portion designed to come into leaktight tight-fitting contact in the opening. Thus, sealing may be provided by tight-fitting contact below the segment in which the vent is formed. The bottom segment may have a constant diameter so as to form a cylinder, but it may also have a varying diameter including at least a portion that can come into leaktight tight-fitting contact in the opening. The leaktight contact established at the bottom segment does not interrupt the communication that exists between the reservoir and the outside through the vent.

In a variant embodiment, the top segment or the bottom segment, or each of the top segment and the bottom segment forms an outwardly-projecting bead designed to flatten in the opening of the reservoir. Once the bead is flattened against the inside wall of the opening, the remainder of the top segment and/or of the bottom segment can also come into leaktight tight-fitting contact with the inside wall of the opening. However, the tight-fitting contact is stronger at the flattened bead.

In another aspect of the invention, the skirt forms an abutment flange designed to come into abutting contact with the opening. The flange coming into abutment on the top end of the opening marks the final fitted position of the fixing member, in which the vent is advantageously isolated from the outside by the larger-diameter top segment.

According to another characteristic of the invention, the top segment is provided with at least one vertical groove having one end that is designed to communicate with the vent when the top segment is in tight-fitting contact in the opening of the reservoir. Thus, even when the larger-diameter top segment comes into contact with the inside wall of the opening of the receptacle, the vent can still continue to perform its venting function until the top end of the groove is closed off. It is even possible to make provision for the top end of the groove to extend to the top of the larger-diameter top segment, i.e. to immediately below the abutment flange. In which case, sealing can be established against the abutment flange.

According to another characteristic which may be implemented in combination with the preceding characteristic, the vent is formed at a smaller-diameter middle segment designed to remain out of contact with the opening of the reservoir. Thus, once it is engaged inside the opening of the reservoir, the middle segment forms an annular gap which can communicate with the groove advantageously formed at the top segment. This makes it possible to form the vent without any angular positioning requirement because it is the annular gap that establishes the communication between the vent and the vertical groove(s).

According to another characteristic of the invention, the fixing member forms an internal ferrule against which at least one component of the dispensing member is urged elastically in the rest position.

The present invention also provides a fluid dispenser comprising a reservoir, a dispensing member, and a fixing member of the invention.

### BRIEF DESCRIPTION OF THE DRAWINGS

The invention is described below with reference to the accompanying drawings which show embodiments of the invention by way of non-limiting example.

In the figures:

FIG. 1 is a front view of a first embodiment of a fixing member of the invention;

FIG. 2 is a view in vertical section showing the right portion of the fixing member of FIG. 1;

FIG. 3 is a view in vertical section through the fixing member of FIG. 1, as associated with a dispensing member, while it is being fitted in the opening of a reservoir;

FIG. 4 is a view similar to the FIG. 3 view, with the fixing member in its final fitted position in the opening of the reservoir; and

FIGS. 5, 6, 7, and 8 are views in vertical section through skirts of fixing members in four. other embodiments of the invention.

### DETAILED DESCRIPTION OF THE INVENTION

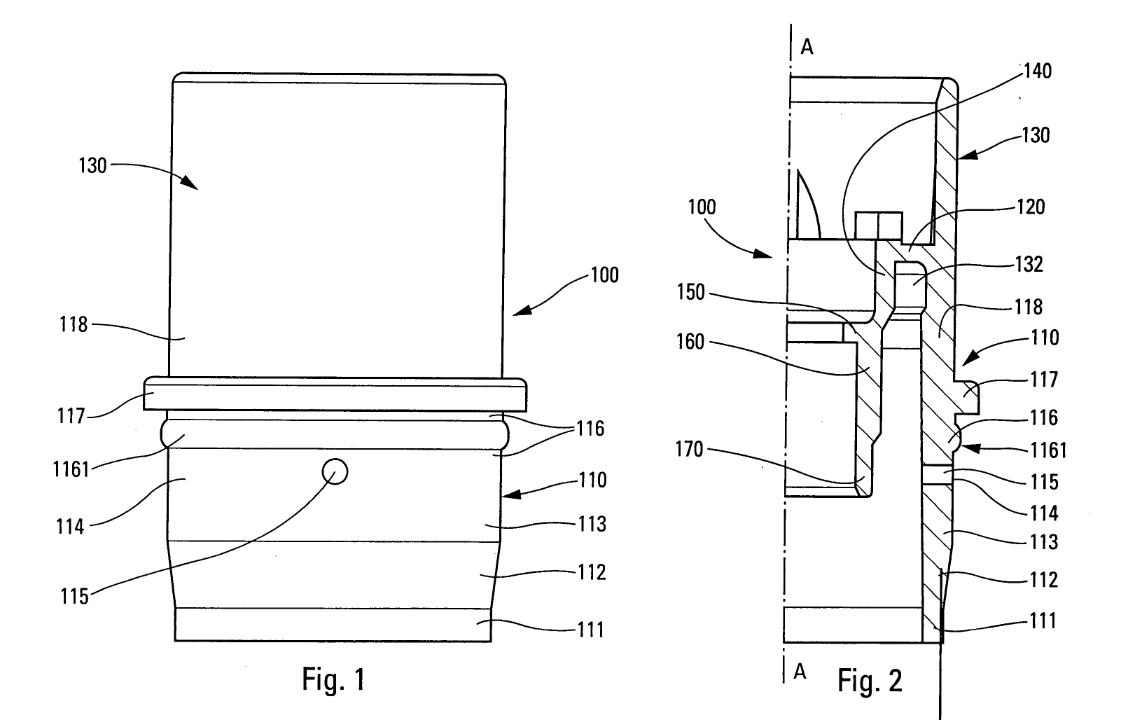

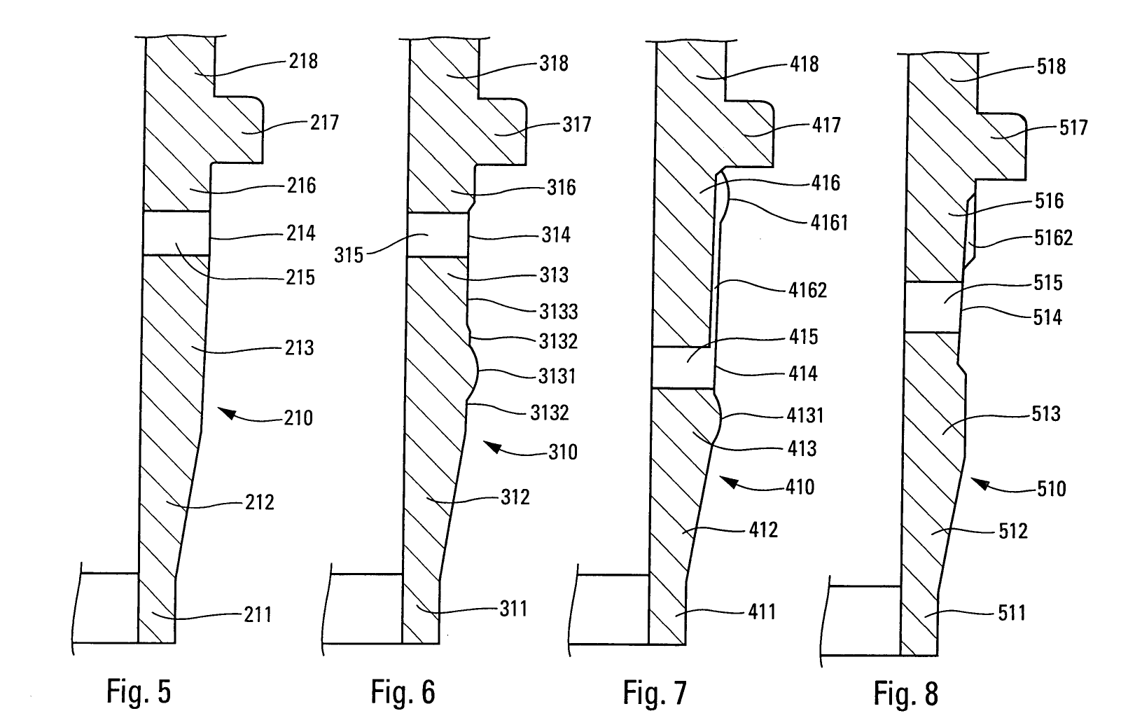

Reference is made firstly to FIGS. 1 and 2 to explain the structure of a fixing member 100 in a first embodiment of the invention. Like the others shown in FIGS. 5 to 8 that are described below, this fixing member 100 may be made of a molded plastics material. It is substantially circularly symmetrical about the axis AA of FIG. 2. The fixing member 100 is provided with a skirt 110 which is substantially cylindrical. The skirt 110 is extended upwards by a sleeve 130 which extends substantially in alignment with the skirt 110. Where the sleeve 130 is connected to the skirt 110, the fixing member is provided with a radial flange 120 which extends inwards. Over its inner periphery, the radial flange 120 is extended downwards by forming a substantially cylindrical ring 140. The ring 140 is itself extended downwards to form firstly an inwardly-extending shoulder 150 and then a substantially cylindrical ferrule 160 which is terminated by an abutment bottom end 170. The skirt 110, the flange 120, and the ring 140 define an internal recess 132 whose function is given below.

The sleeve 130, the flange 120, the ring 140, the shoulder 150, and the ferrule 160, and the top portion of the skirt 110 may be common to all of the embodiments of FIGS. 5 to 8. The present invention is situated particularly at the skirt 110, and more particularly at the bottom portion of the skirt.

Starting from the bottom of the skirt 110, it forms firstly a bottom end segment 111 whose outside diameter is advantageously smaller than the inside diameter of the receptacle opening in which the fixing member 100 is designed to be fitted. Above the bottom end 111, the skirt forms a transition segment 112 which, in this example, has a substantially frustoconical outside wall. Above the transition segment 112, the skirt forms a bottom segment 113 which, in this example, is substantially or entirely cylindrical. Above this segment 113, the skirt forms an intermediate segment 114 at which a vent 115 is formed through the thickness of the skirt, as can be seen in FIG. 2. In this example, the intermediate segment 114 is substantially or entirely cylindrical and is connected to the bottom segment 113 continuously. It is even possible to make provision for the outside diameters of the segments 113 and 114 to be identical. Above the segment 114, the skirt forms a top segment 116 which, in this example, is provided with a bead 1161 that projects radially outwards. The bead 1161 forms a portion of the outside wall of the top segment 116, but the remainder of the outside wall of the top segment 116 may be substantially or entirely cylindrical, and it has an outside diameter that is advantageously identical to the diameter of the intermediate segment 114 and of the bottom segment 113. This can be seen clearly in FIG. 1. It can thus be said that, above the frustoconical segment 112, the skirt forms a cylindrical portion that is provided with a projecting bead 1161 in the vicinity of its top end.

Above the top segment 116, the skirt forms an abutment flange 117 which also projects radially outwards. Beyond said flange 117, the skirt forms a recess segment 118 which forms part of the recess 132 with the coupling flange 120 and the ring 140.

The inside wall of the skirt 110 may be substantially or entirely cylindrical.

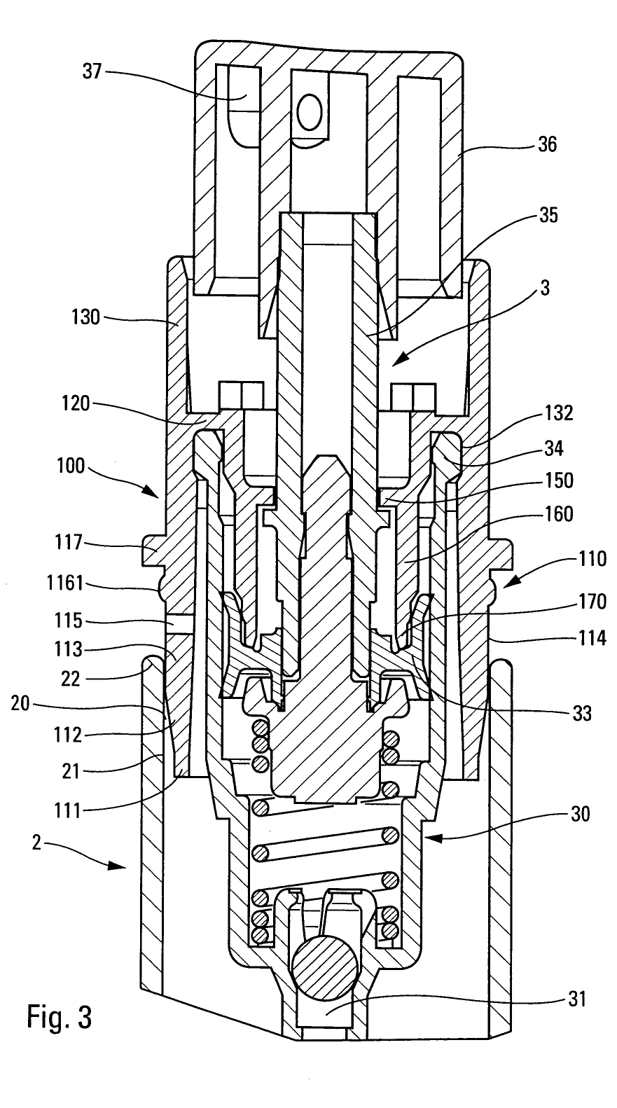

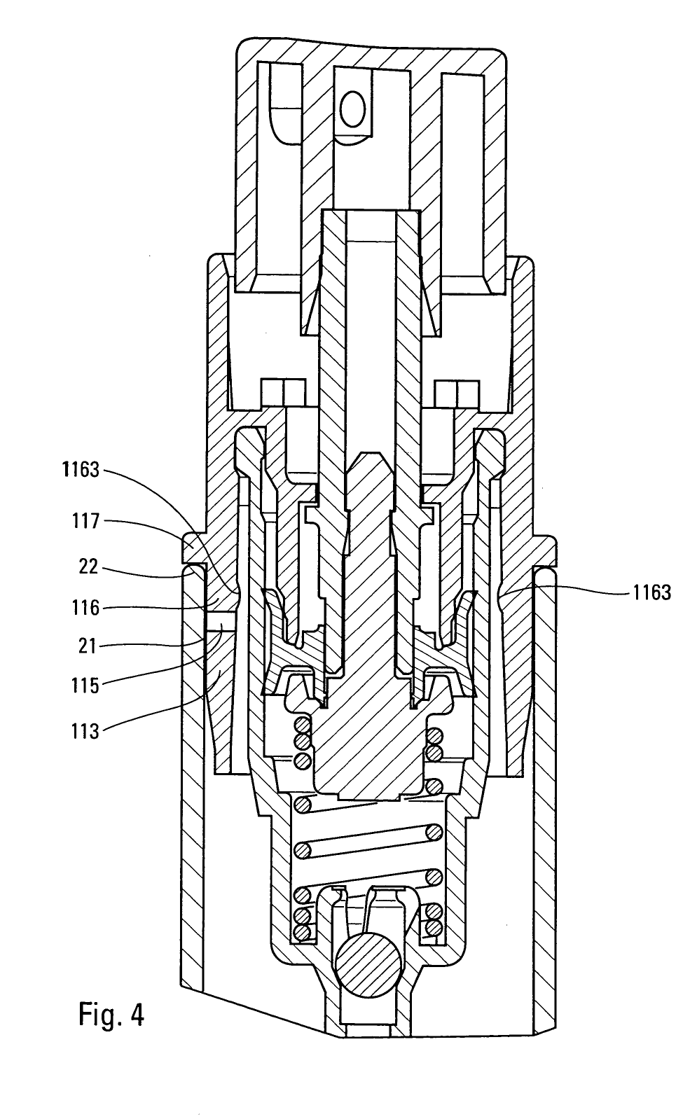

Reference is made below to FIGS. 3 and 4 to explain how the fixing member 100 of FIGS. 1 and 2 interacts while it is being fitted in the opening of a receptacle or of a reservoir for fixing a dispensing member to the reservoir. The receptacle or reservoir 2 defines an opening 20 defined by an inside wall 21 which is, for example, substantially or entirely cylindrical. The opening 20 is defined by a top edge 22. The reservoir may be a small bottle comprising a cylindrical drum closed off by a bottom.

As regards the dispensing member 3, it may be a valve or a pump, as in the example used to illustrate the invention. The internal structure of the pump 3 is not described in detail since it is not critical for the present invention. For example, the pump 3 may have a pump body 30 internally defining a pump chamber provided with an inlet 31. A piston 33 mounted on an actuating rod 35 and capped with a pusher 36 equipped with a nozzle 37 can thus slide in the pump body 30 to modify the volume of the pump chamber and thus put the fluid stored in the chamber under pressure before it is delivered through the actuating rod 35 to be dispensed at the nozzle 37. For example, the pump body 30 may be provided with a snap-fastening reinforcement 34 situated at its top end. The snap-fastening reinforcement 34 is designed to come into snap-fastening engagement in the recess 132 formed by the fixing member 100. This is merely a non-limiting embodiment: naturally, other embodiments may be imagined for the means provided in the fixing member for receiving the dispensing member 3. However, this embodiment is entirely conventional.

FIG. 3 shows the fixing member 100 as partially engaged in the opening 20 of the reservoir 2. More precisely, the skirt 110 of the fixing member is already partially engaged in the opening 20, and is already in leaktight tight-fitting contact with the inside wall 21 at its bottom segment 113. For this purpose, the outside diameter of the bottom segment 113 must be chosen to be equal to or slightly larger than the inside diameter of the inside wall 21. Naturally, both the bottom end segment 111 and the transition segment 112 have diameters significantly smaller than the diameter of the wall 21, hence an intermediate space exists as can be seen in FIG. 3. Thus, by means of the bottom segment 113, leaktight annular contact is already formed between the fixing member and the reservoir. However, the inside of the reservoir can still communicate with the outside via the vent 115 which is situated above the bottom segment 113. Naturally, the body 30 of the pump 3 must not be in contact with the vent 115 in a manner such as to close it off permanently and hermetically. To this end, and as shown in FIG. 3, a free annular space exists between the body 30 and the skirt 110.

Since the outside diameter of the bottom segment 113 is identical to the outside diameter of the intermediate segment 114 at which the vent 115 is formed, the vent 115 is closed off hermetically as soon as the intermediate segment 114 has penetrated into the opening 20. As soon as the hole 115 is closed off, the inside of the reservoir no longer communicates with the outside. The sealing established extends over a cylindrical segment covering the bottom segment 113 and the intermediate segment 114. As the skirt 110 continues to be pushed into the reservoir, the top segment 116 also penetrates into the opening in the reservoir. As a result, the projecting bead 1161 is stressed inside the reservoir, thereby forming very tightly-fitting contact. Advantageously, the fixing member 100 is made of a plastics material that is significantly deformable so that the bead 161 is partially or entirely flattened against the inside wall 21 of the opening 20. As a result, the skirt 110 is subjected to deformation at its inside wall in the form of an annular projection 1163, as shown in FIG. 4. Thus, the top segment 116 is then substantially or entirely cylindrical inside the reservoir. The final fitted position is reached when the abutment flange 117 comes into abutting contact with the top edge 22 of the reservoir. This is shown in FIG. 4. It can then be observed that the skirt 110 is externally entirely cylindrical at the level corresponding to the segments 113, 114, and 116. Sealing is established over the entire height of these segments, with tighter contact at the flattened bead 1161.

Since the vent 115 is situated in the vicinity of the abutment flange 117, the stroke of the skirt 110 inside the opening with the vent closed off is short. Therefore, the extra pressure generated inside the reservoir is very limited.

Without going beyond the ambit of the invention, provision may be made for only one or two segments from among the segments 113, 114, and 116 to form leaktight tight-fitting contact, and advantageously segment 116 because it closes off the vent at the last minute.

Reference is made below to FIG. 5 which shows a second embodiment of a fixing member of the invention. The numerical references of the first embodiment start from 100. For the second embodiment, the numerical references start from 200, and so on for the other three embodiments.

The fixing member 200 is provided with a skirt 210 defining a bottom end segment 211 and a transition segment 212 which may be strictly identical to those of the first embodiment. The same applies for the abutment flange 217 and for the recess segment 218. The bottom segment 213 and the intermediate segment 214 are, in this example, also identical to those of the first embodiment, i.e. substantially or entirely cylindrical in shape with an outside diameter equal to or slightly larger than the diameter of the inside wall 21 of the neck in which the skirt is to be engaged by force. But in this example, the top segment 216 is also substantially or entirely cylindrical and it extends in alignment with the intermediate segment 214. Thus, the segments 213, 214, and 216 form a substantially or entirely cylindrical portion having a diameter that is substantially constant and equal to or slightly larger than the inside diameter of the opening in the neck. Sealing inside the neck is thus established by cylinder-on-cylinder contact, thereby closing off the vent 215.

FIG. 6 shows the skirt 310 of a fixing member 300 which is identical to the preceding embodiment at the segments 311, 312, 317, and 318 corresponding respectively to the segments 211, 212, 217, and 218 of FIG. 5. Conversely, above the transition segment 312, the bottom segment 313 forms a first segment that is substantially cylindrical 3132, and then a projecting bead 3131 which is extended by another substantially cylindrical segment 3132. The two substantially cylindrical segments 3132 advantageously have the same outside diameter which may be equal to or slightly larger than the inside diameter of the opening of the receptacle. The projecting bead 3131 is adapted to flatten against the inside wall 21 of the receptacle by generating, for example, an internal projection comparable to the projection shown in FIG. 4 with the numerical reference 1163. As a result, once the bead 3131 is flattened against the inside wall 21, it may return substantially to within the same cylinder as that defined by the adjacent segments 3132. Above the second substantially cylindrical segment 3132, the bottom segment forms a third segment 3133 whose outside diameter is.smaller than the outside diameter of the segments 3132. The diameter of the segment 3133 is preferably smaller than the diameter of the inside wall 21 of the reservoir 2. Thus, once the segment 313 is engaged in the opening in the receptacle, there remains an annular gap defined between the outside wall of the segment 3133 and the inside wall 21. The intermediate segment 314, at which the vent 315 is formed, extends in alignment with the segment 3133, and may even have the same diameter as it. Thus, the vent 315 can communicate with the annular gap formed at the segments 3133 and 314 even when the skirt is engaged in a receptacle opening. Above the intermediate segment 34, the top segment 316 may be identical to the corresponding segment of FIG. 5, referenced 216. In other words, the top segment 316 may be substantially or entirely cylindrical, and have an outside diameter equal to or slightly greater than the inside diameter of the wall 21. Advantageously, the outside diameter of the segments 3132 and 316 is identical. The skirt being engaged into a neck results in two cylindrical sealing zones separated by an annular gap. As in the preceding embodiment, the vent 315 establishes communication between the inside of the reservoir and the outside until the top segment 316 comes into leaktight tight-fitting engagement inside the opening in the reservoir.

In the embodiment shown in FIG. 7, the skirt 410 forms segments 411, 412, 417, and 418 that may be identical to the corresponding segments in the preceding embodiments. The bottom segment 413 may also be provided with a projecting bead 4131 serving to flatten against the inside wall 21 of the reservoir. Directly above the bead 4131, the skirt forms the intermediate segment 414 at which the vent 415 is situated. Above the segment 414, the top segment 416 extends over a larger height than in the preceding embodiments by forming a segment that is substantially or entirely cylindrical in alignment with the intermediate segment 414, and a projecting bead 4161 situated in the vicinity of or immediately below the flange 417. A groove 4162 extends over a portion or even all of the height of the top segment 416. The groove extends vertically and, via its bottom end, connects to the vent 415. The outside diameter of the intermediate segment 414 and of the top segment 416 in its cylindrical portion is advantageously identical to or slightly larger than the inside diameter of the reservoir at the inside wall 21. The beads 4131, 4161 are designed to flatten against said inside wall 21. Thus, cylindrical sealing is provided but it is interrupted at the groove 4162. However, full peripheral sealing is provided at the bead 4131. Similarly, sealing may be provided at the flange 417 against which the end edge 22 can come into leaktight abutment. With this embodiment, venting is possible until the final fitted position is reached because the groove 4162 puts the vent 415 into communication with the outside even when the inside wall 21 is already engaged at the top segment 416. Since the groove 4162 interrupts the sealing at the top segment 416, the main function of said top segment is a fixing and retaining function. The sealing function and also the fixing function is performed by the bottom segment 413. However, the groove may terminate below the bead 4161, so that said bead performs complete annular sealing.

The last embodiment implements a skirt 510 including segments 510, 512, 517, and 518 identical to the corresponding segments of the preceding embodiments. The bottom segment 513 may firstly have a portion that is substantially or entirely cylindrical and whose diameter is equal to or slightly larger than the inside diameter of the wall 21. It is also possible to form this bottom portion of the bottom segment 513 with an outside diameter smaller than the inside diameter of the inside wall 21, so that there is no sealing at said portion. Above this bottom portion, the segment 513 may form a top other portion whose diameter is smaller than the diameter of the wall 21. The intermediate segment 514 may also have a diameter smaller than the diameter of the inside wall 21. The top segment 516 may firstly extend in alignment with the segment 514, with the same diameter, and then return to a diameter equal to the diameter of the bottom portion of the segment 513. However, a portion of the segment 516 is provided with one or more vertical grooves 5162 that extend from the small-diameter portion upwards without reaching the flange 517. Thus, once the skirt 510 is engaged in the reservoir, full leaktight tight-fitting contact over the entire periphery is provided at the bottom segment 513, and at the top end of the segment 516 above the groove 5162. Between the two full leaktight peripheral contacts, the vent 515 can communicate with an annular gap which extends all the way around the skirt because the skirt is not in contact with the wall 21 at the intermediate segment 514 and at the bottom portion of the intermediate segment 516. This makes it possible for the vent to communicate with the groove 5162. As a result, with this embodiment, it is possible to vent the reservoir through the vent 515 and the groove 5162 until the inside wall 21 reaches the top end portion of the segment 516 that is not provided with grooves 5162. Thus, almost total venting of the reservoir and excellent leaktightness are achieved simultaneously.

Naturally, the teaching provided by these five embodiments may be mixed to form other embodiments without going beyond the ambit of the invention. For example, the skirt 410 of FIG. 7 may be provided with one or even two projecting beads. Furthermore, the embodiment of FIG. 1 may also be provided with a communication groove that extends at the segment 116. it is also possible to form one or two segments chosen from the bottom, middle, and top segments, with an outside diameter that is smaller than the inside diameter of the inside wall 21 of the opening, so that there is no leaktight contact at said segment(s). It is even possible to make provision for there to be no full peripheral leaktight contact at the bottom, middle, and top segments. For example, by choosing one or more grooves that are sufficiently long and/or sufficiently narrow, it is possible both to provide venting during fitting, and also to avoid any leakage of fluid by capillary action.

By means of the invention, it is possible to make fixing members enabling the reservoir to be vented simply and reliably.

1/ A fixing member (100; 200; 300; 400; 500) for fixing a dispensing member (3) to an opening (20) of a reservoir (2), said fixing member having means (132; 232; 332; 432; 532) designed to receive the dispensing member, and a substantially cylindrical skirt (110; 210; 310; 410; 510) designed to be engaged in the opening of the reservoir to establish leaktight contact therein, said fixing member being characterized in that the skirt is provided with at least one vent (115; 215; 315; 415; 515) passing through the thickness of the skirt.

2/ A fixing member according to claim 1, in which the vent is formed below a larger-diameter top segment (116; 216; 316; 416; 516) designed to come into leaktight tight-fitting contact in the opening.

3/ A fixing member according to claim 1, in which the vent is formed at a larger-diameter middle segment (114; 214; 314; 414; 514) designed to come into leaktight tight-fitting contact in the opening.

4/ A fixing member according to claim 1, in which the vent is formed above a bottom segment (113; 213; 313; 413; 513) including a larger-diameter portion designed to come into leaktight tight-fitting contact in the opening.

5/ A fixing member according to claim 2, in which the top segment (116; 416) forms an outwardly-projecting bead (1161; 4161) designed to flatten in the opening.

6/ A fixing member according to claim 4, in which the bottom segment (313; 413) forms an outwardly-projecting bead (3131; 4131) designed to flatten in the opening.

7/ A fixing member according to claim 1, in which the skirt forms an abutment flange (117; 217; 317; 417; 517) designed to come into abutting contact with the opening.

8/ A fixing member according to claim 2, in which the top segment (416; 516) is provided with at least one vertical groove (4162; 5162) having one end that is designed to communicate with the vent (415; 516) when the top segment is in tight-fitting contact in the opening of the reservoir.

9/ A fixing member according to claim 1, in which the vent (315; 515) is formed at a smaller-diameter middle segment (314; 514) designed to remain out of contact with the opening of the reservoir.

10/ A fixing member according to claim 1, forming an internal ferrule (160; 260; 360; 460; 560) against which at least one component (33) of the dispensing member (3) is urged elastically in the rest position.

11/ A fluid dispenser comprising a reservoir (2), a dispensing member (3), and a fixing member (100; 200; 300; 400; 500) according to any preceding claim.

12/ A fluid dispenser according to claim 11, in which the skirt surrounds the dispensing member with a free annular space between them at the level of the vent.
